(19) United States
(12) Patent Application Publication
(10) Pub. No.: US 2026/0053292 A1
(43) Pub. Date: Feb. 26, 2026

(54) COFFEE MACHINE AND METHOD FOR PREPARING A COFFEE DRINK

(71) Applicant: Coffee Vision AG, Luzern (CH)

(72) Inventor: Georg Josef Feierabend, Aarburg (CH)

(21) Appl. No.: 18/879,867

(22) PCT Filed: Jun. 30, 2023
(86) PCT No.: PCT/EP2023/068035

§ 371 Date: Dec. 30, 2024

(30) Foreign Application Priority Data
Jul. 1, 2022 (CH) CH000797/2022

(51) Int. Cl. A47J 31/44; A47J 31/06; A47J 31/42

(52) U.S. Cl. CPC A47J 31/4467; A47J 31/0663; A47J 31/42

(57) ABSTRACT

A coffee machine including a machine unit and a portafilter device with a coffee receiving space and a brewing filter. The portafilter device is removable from the machine unit. The machine unit includes a movably mounted brewing piston, a brewing water preparation device for producing and delivery hot water under pressure into the coffee receiving space of the portafilter device, and a holding and guiding device for receiving and holding the portafilter device on the machine unit.

The holding and guiding device has a linear guide device for the linear insertion of the portafilter device into the machine unit.

### BACKGROUND OF THE INVENTION

### Field of the Invention

The invention lies in the field of coffee machines and relates to a coffee machine with a machine unit and with a portafilter device which can be removed from the machine unit, for creating, in particular brewing a coffee drink, and to a method for brewing a coffee drink.

### Description Of Related Art

Coffee machines with portafilter devices, portafilters for short, are also denoted as portafilter machines. Portafilter machines are widespread amongst coffee machines. There are portafilter machines for the private household as well as for the restaurant business. Portafilter machines operate in a semi-automatic manner by way of certain operating steps being effected manually. Thus, the portafilter which receives the coffee powder, according to the common state of the art is manually removed from the coffee machine for filling with coffee powder before the brewing procedure as well as for removing the coffee grounds after the brewing procedure.

In particular, coffee powder in the present description is to be understood as coffee which has been ground, thus ground coffee. Coffee grounds in the present description are to be understood as the pressing residue after the brewing procedure, which is also denoted as coffee sediment.

Concerning portafilter machines, the coffee power is filled into the portafilter outside the coffee machine. Certain portafilter devices include an attached grinder. Here, the portafilter which is separated from the coffee machine is held below the dispensing opening of the grinder for filling with coffee power and is subsequently manually fastened to the coffee machine in the brewing position.

This is in contrast to coffee machines which operate in a fully automatic manner and concerning which the coffee power goes directly from an integrated grinder into the brewing chamber and the coffee grounds are automatically expelled into an integrated capture container after the end of the brewing procedure.

The portafilter as a rule is fastened to the coffee machine via a quick-release fastener. Known portafilters include a portafilter housing with several radially outwardly projecting projections which interact with a guide contour which is provided on the part of the machine at the connection section and herein form a bayonet fastener between the portafilter and the connection section. For attaching the portafilter to the coffee machine, the portafilter is applied onto the connection section from below in a manner such that the projections on the portafilter engage into the guide contour. The portafilter is subsequently fastened to the coffee machine whilst exerting a rotation movement with the handle.

This type of fastening mechanism has the disadvantage that the attachment of the portafilter is quite cumbersome and difficult. For instance, the portafilter must be applied on the connection section from below at the correct angular position, so that the projections engage into the guide contour. Moreover, the fastening of the portafilter by way of rotation movement necessitates an increased for effort. If the guide contour is dirtied, e.g. by way of coffee grounds, then under certain circumstances the portafilter cannot be fastened in the desired rotation position.

EP 3 954 256 A1 describes for example a portafilter machine with a portafilter as are known from the state of the art.

The pressing of the coffee powder in the coffee receiving space of the portafilter device, such pressing preceding the brewing procedure and being particularly important e.g. for the preparation of an espresso with crema, with certain portafilter machines is effected by way of the portafilter being pressed upwards against a stationary tamper on fastening to the coffee machine. Such portafilter machines as a rule use different filter baskets, by way of which the quantity of coffee powder which is used for the brewing procedure can be varied.

However, portafilter machines which for the pressing of the coffee powder, the so-called “tampering”, include a movable brewing piston which can be pressed downwards to the portafilter via a hand lever are also known.

### SUMMARY OF THE INVENTION

It is then the object of the present invention to suggest a coffee machine with a portafilter device which permits a simple and rapid attachment of the portafilter device on the coffee machine.

Moreover, it is an object of the present invention to suggest a coffee machine which permits a defined pressing of the coffee powder even given a different filling of the portafilter with coffee power and without the use of filter inserts of a different size.

A further object lies in putting forward a coffee machine which ensures a simple, rapid and in particular reliable filling of the portafilter device with coffee powder.

A further object lies in putting forward a coffee machine with a grinder which permits an change of the coffee variety without residue.

At least one object is achieved by the features of the independent claims. The dependent claims, the description and the figures include particular embodiments and further developments of the invention.

The coffee machine includes a machine unit and a portafilter device with a coffee receiving space and with a brewing filter, the portafilter device being removable from the machine unit. The machine unit includes a movably mounted brewing piston, a brewing water preparation device for generating and delivering hot water under pressure into the coffee receiving space of the portafilter device and a holding and guiding device for receiving and holding the portafilter device on the machine unit.

“Removable” in particular means that the portafilter device is completely separable from the machine unit without a permanent connection to the machine unit. Herein, the portafilter device in particular can be removed from the machine unit or attached to this via a handle. The attachment and the removal of the portafilter device in particular are effected in a tool-free manner.

The portafilter device in particular can be removed from the machine unit for removing the coffee grounds after a brewing procedure. Supplementary, the portafilter device unit can also be removable from the machine unit for filling the portafilter device with coffee powder.

The invention is characterised in that the holding and guiding device includes a linear guide device for the linear, i.e. straight-lined insertion of the portafilter device into the machine unit.

The portafilter device in particular can also be withdrawn from the machine unit again by way of a corresponding, linear, i.e. straight-lined counter-movement via the linear guide device.

In particular, the linear guide device includes two parallel running guide contours such as guide rails, which are spaced from one another. The guide contours can form a guide slot or a guide channel.

The linear guide device in particular is arranged below a brewing unit and possibly below a device for delivering coffee powder, in particular for producing and delivering coffee powder.

The linear guide device can be arranged on a carrier plate or be part of a carrier plate. The brewing unit and possibly the device for delivering coffee powder, in particular for producing and delivering coffee powder can be arranged or fastened on the carrier plate.

In particular, the portafilter device includes a portafilter housing in which the coffee receiving space is arranged. Guide bodies, in particular at least two oppositely lying guide bodies which interacting with the linear guide device, form a linear guide and are arranged laterally on the portafilter housing. The guide bodies in particular are designed as lateral guide bars which in particular run parallel to one another.

The linear movement which is executed via the linear guide device in particular is horizontal.

In particular, the portafilter device can be inserted into the machine unit along or parallel to an insertion plane via the linear guide device. In particular, the insertion plane is aligned horizontally.

The horizontal movement or the insertion plane however necessitate the coffee machine or machine unit being supported on a horizontal rest.

In particular, the linear guide is a sliding guide concerning which the guide bodies slide in the linear guide device or in the guide contours.

The portafilter device which is mounted or held in the linear guide device can be moved in the machine unit into a brewing position for brewing a coffee.

The portafilter device can be pushed or moved into the brewing position in particular in a linear movement via the linear guide device.

The brewing position is formed in the machine unit in particular below the brewing unit. In particular, it corresponds to that position which the portafilter device has or assumes during the brewing process.

According to a further development of the invention, the machine unit includes a device for delivering and in particular producing and delivering coffee powder into the coffee receiving space of the portafilter device.

The portafilter device which is mounted or held in the linear guide device can be moved in the machine unit into a filling position for delivering coffee powder into the coffee receiving device of the portafilter device.

The portafilter device can be pushed or moved into a filling position in particular in a linear movement via the linear guide device, in which filling position the coffee receiving space of the portafilter device is fillable with coffee powder.

The filling position is different from the brewing position. The filling position and the brewing position in particular lie in a common horizontal plane.

The filling position is formed in the machine unit in particular below a grinder. The filling position in the machine unit however can also be formed below the coffee powder delivering device. The coffee powder delivering device can include a container for storing coffee powder, the container having to be filled with coffee powder in a manual manner.

The portafilter device which is mounted or held in the linear guide device is movable in the machine unit between the filling position and the brewing position.

The portafilter device which is linearly pushed into the machine unit via the linear guide device is movable in the machine unit between the filling position and the brewing position.

The portafilter device is movable in the machine unit between the filling position and the brewing position in particular in a plane, very particularly in a horizontal plane.

The movement of the portafilter device between the filling position and the brewing position can be a linear movement. This is particularly the case when the portafilter device is moved in the linear guide device between the filling position and the brewing position.

The movement of the portafilter device between the filling position and the brewing position can be a pivoting movement as is yet described in more detail further below.

The portafilter device is mounted or held in the machine unit given the movement between the filling position and the brewing position in the linear guide device via which the portafilter device has already been inserted into the machine unit.

According to a first embodiment variant, the brewing position and the filling position are arranged one after the other along the insertion axis of the portafilter device.

In particular, the filling position is arranged after the brewing position in the insertion direction. For initiating a brewing procedure, the portafilter device is pushed into the machine unit in a linear movement until the assumption of the filling position and after filling the portafilter device with coffee powder is retracted into the brewing position in a linear counter-movement. After completion of the brewing procedure, the portafilter device is completely pulled out of the machine unit in a continuation of the linear counter-movement.

Alternatively, the filling position can also be arranged in front of the brewing position in the insertion direction. For initiating a brewing procedure, the portafilter device is pushed into the machine unit in a linear movement until the assumption of the filling position. After filling the portafilter device with coffee powder, the portafilter device is pushed further into the brewing position in a continuation of the linear insertion movement. After completion of the brewing procedure, the portafilter device is pulled completely out of the machine unit past the filling position in a linear counter-movement.

According to this embodiment, the linear guide device is attached to the machine unit in particular in an immovable or stationary manner.

According to a second embodiment variant, the linear guide device is pivotably mounted on the machine unit via a pivot axis which is arranged perpendicularly to the insertion plane. The portafilter device which is pushed into the machine unit via the linear guide device is pivotably mounted together with the linear guide device between a filling position and the brewing position.

The portafilter device in this case can be inserted relative to the linear guide device into a working position in which the portafilter device is pivotable relative to the device for delivering or producing and delivering coffee powder and relative to the brewing unit, between the filling position and the brewing position.

According to a further development of the invention, latching means can be provided, the latching means permitting the assumption of a latching position of the portafilter device in one or more of the following positions:
filling position (first embodiment variant);
brewing position (first embodiment variant);
working position (second embodiment variant).

The latching means are designed for positioning the portafilter device in the respective position by way of assuming a latching position. The latching means in particular effect an exact positioning in the respective position. The latching means in particular effect a self-centring of the portafilter device in the respective position.

In particular, the latching means are designed such that the portafilter device can be pushed further or pulled back beyond the latching position, possibly by way of an increased force effort.

The latching means for example can be spring-loaded push-buttons or balls which in the respective position engage into a recess in the linear guide device during the linear movement of the portafilter device. The spring-loaded buttons or balls can be arranged e.g. on the portafilter device, in particular on the guide bodies. The recesses can be arranged e.g. in the guide rails or guide slots or guide channels.

The recesses in particular include ramps in and counter to the insertion direction, the ramps simplifying the moving of the portafilter device out of the latching position in both directions, which is to say reducing the force effort. In particular, this is of relevance if the portafilter device is to be moved further beyond the latching position.

According to a further development of the invention, stop means as an insertion limitation can be provided in the machine unit, in particular on the holding and guide device or the linear guide device, by way of which stop means the portafilter device can be positioned in one of the following positions:
filling position (first embodiment variant);
brewing position (first embodiment variant);
working position (second embodiment variant).

The stop means in particular effect an exact positioning in the respective position by way of the abutting of the portafilter device on the stop means.

The portafilter device in particular includes a handle for the manual insertion of the portafilter device into the machine unit and for the manual withdrawal out of the machine unit.

The coffee receiving space of the portafilter device in particular can be formed by a filter basket with a brewing filter, the filter basket being integrated into the portafilter housing. The coffee receiving space of the portafilter device in particular can be formed by a filter basket with a brewing filter, the filter basket being fixedly built in the portafilter housing. The filter basket however can also be removable.

Since according to the present invention, the movably mounted brewing piston is advanced into the coffee receiving space of the portafilter device for pressing (tampering) the coffee powder and for closing the brewing chamber, one does not need differently large filter inserts for different quantities of coffee powder.

The brewing piston in particular is part of a brewing unit which is formed in the machine unit and includes a piston tamper. The piston tamper is arranged at the brewing side. The piston tamper in particular is connected to a piston rod which is guided in a piston rod housing. The brewing piston and the piston rod housing in particular are part of the brewing unit in the machine unit.

The brewing unit together with the portafilter device in particular forms a brewing group.

In particular, the brewing piston is driven. The drive can be effected manually, e.g. via a lever mechanism, or also via a control device by way of a piston drive.

The piston drive can include an electric motor. The brewing piston can thus be driven by the electric motor via a drive spindle.

The piston drive can also include a hydraulic drive, by way of which a hydraulic pressure is built up in the pressure chamber via a hydraulic fluid such as water, the hydraulic pressure pushing the brewing piston into the brewing position. The hydraulic pressure can be between e.g. 2 and 3 bar.

The hydraulic drive can be the water pump of a brewing water preparation device of the machine unit. The hydraulic fluid is accordingly water from the water tank of the brewing water preparation device. The drive here is effected via a hydraulic pressure which is generated by the water pump and which acts upon the brewing piston.

The coffee receiving space or the coffee receiver which is formed in the coffee receiving space in particular is arranged in the machine unit in a stationary or immovable manner, in particular during the brewing procedure. The same consequently applies to the portafilter device.

The coffee receiving space of the portafilter device forms an in particular funnel-like widening towards the outside in the region of a receiver opening. The receiver opening corresponds to that opening which is directed towards the brewing unit of the machine unit and through which the brewing piston with its piston tamper engages into the coffee receiving space amid the formation of the brewing chamber. As a rule, the filling of the coffee receiving space with coffee powder is effected through the receiver opening.

The funnel-like widening effects a self-centring of the portafilter device in the brewing position due to piston tamper of the brewing piston which is moved downwards and engages into the coffee receiving space.

The means for producing and delivering coffee powder in particular include a grinder, such as a conical grinder.

The conical grinder is characterised by an inner-lying stationary grinding cone and an outer-lying, driven grinding ring which surrounds the grinding cone. The grinding ring in particular is driven by a drive, such as an electric motor. In particular, a drive means of the drive, such as a drive spindle, and the lateral surface of the grinding ring form a drive pairing for driving the grinding ring. The lateral surface of the grinding ring in particular forms a roughness pattern, such as a corrugation or toothing.

The conical grinder in particular is designed and arranged in the machine unit such that the ground coffee powder falls downwards out of the conical grinder without guidance by way of gravity into the coffee receiving space which is arranged below, of the portafilter device which is pushed into the filling position in the machine unit.

Regarding conventional conical grinders with which the grinding cone is driven, the coffee powder is led away obliquely downwards over an inclined guide surface. The guide surface amongst other things is provided due to the fact that a direct, in particular guidance-free leading-away of the coffee powder vertical device downwards is not possible due to reasons of space. Amongst other things, this is due to the drive of the grinding cone which is arranged below the grinding cone in the extension of the cone axis.

Small quantities of coffee powder remaining sticking on the guide surface after a grinding procedure, so that with the first grinding procedure coffee powder residues of the prior grinding procedure still get into the portafilter after a change of coffee beans. This disadvantage is overcome by the present cone grinder.

For this, the grinding ring and the grinding cone in particular are arranged in a housing. The housing can be of one part or of several parts. The grinding ring is rotatably mounted in the housing in particular via a bearing, e.g. a ball bearing.

Coming from the cone base the grinding cone tapers upwards. The stationary grinding cone is connected to the housing in particular via connection webs. The cone axis of the grinding cone in particular is aligned vertically.

Very particularly, the grinding cone is connected to the housing at its two cone ends, particularly in each case via connection webs.

In particular, the connection webs run transversely to the (geometric) cone axis of the grinding cone. The connection webs for example coming from the cone axis can run outwards towards the housing in a radial or star-like manner.

In particular, one or more through-openings for the passage of coffee beans downwards into the grinder are formed between the connection webs at the upper end of the grinding cone.

In particular, one or more through-openings for the passage of coffee powder downwards out of the grinder are formed between the connection webs at the lower end of the grinding cone, i.e. on the cone base.

The invention further also relates to a method for brewing a coffee drink with a coffee machine as described above. According to definition, all preparation types of coffee which are possible with a portafilter device machine fall under the term coffee drink. These are e.g. black coffee, espresso, espresso lunge, ristretto, etc. Moreover, according to definition all preparation types with milk as an addition, such as e.g. cappuccino or latte macchiato fall under the term coffee drink. For this, the coffee machine can also include a milk preparation device such as a milk frother.

For activating a brewing procedure and in particular also for the selection of the coffee preparation type, the coffee machine can include an input device, e.g. with a display.

The machine unit further includes a control device for operating individual assemblies or devices, such as a water pump, valves and possibly piston drive, grinder or input device etc.

Thus in particular the piston drive is also controlled via the control device. E.g. the amount or degree of the coffee pressing can be set via the input device or presetting. The control device then on the basis of the respective specifications for coffee pressing (degree or amount of coffee pressing) controls the pressing pressure (piston pressure) which is exerted upon the coffee powder via the piston drive.

The method is characterised in that for brewing a coffee, the portafilter device is pushed into the machine unit by way of a linear movement via the linear guide and after completion of the brewing procedure is pulled out of the machine unit again in a linear counter-movement.

The portafilter device in a preparation of the brewing procedure can be filled with coffee powder outside the machine unit and be pushed unit into the machine unit into the brewing position in a linear movement.

Alternatively, the portafilter device can also so be pushed into the machine unit in a linear movement in an empty state. The filling is effected in the machine unit via integrated means for delivering, in particular for producing and delivering coffee powder.

According to the first embodiment variant in which the filling position and the brewing position are arranged behind one another along the insertion axis, for brewing a coffee the portafilter device is firstly pushed into a filling position in a linear movement via the linear guide and after the filling of the coffee receiving space with coffee powder is retracted into a brewing position in a linear counter-movement. In this case, the filling position is arranged after the brewing position in the insertion direction.

Alternatively, i.e. if the filling position is arranged in front of the brewing position in the insertion direction, for brewing a coffee the portafilter device can firstly be pushed into the filling position in a linear movement via the linear guide and after the filling of the coffee receiving space with coffee powder can be pushed further into the brewing position in a continuation of the linear insertion movement.

According to the second variant, regarding which the portafilter device is pivotable together with the linear guide device, for brewing a coffee the portafilter device is pushed into the machine unit in a linear movement via the linear guide and is pushed into a working position relative to the linear guide device. For filling the coffee receiving space with coffee powder and for brewing the coffee, the portafilter device which is in the working position relative to the linear guide device is pivoted together with the linear guide device relative to the device for delivering or producing and delivering coffee powder and relative to the brewing unit, between a filling position and a brewing position.

On pushing the portafilter device into the machine unit, the working position can lie outside the filling position, so that the portafilter device after the insertion into the machine unit must firstly be pivoted into the filling position and subsequently into the brewing position. The filling position and the brewing position are thus defined by the combination of the working position of the portafilter device and the pivoting position of the linear guide device.

The working position can also correspond to the filling position given a corresponding pivoting position on pushing the portafilter device into the machine unit, so that the portafilter device then only needs to be pivoted into the brewing position after filling with coffee powder.

After the positioning of the portafilter device filled with coffee powder in the brewing position, according to both embodiment variants the brewing procedure is initiated by way of advancing the brewing piston parallel to the piston axis into its brewing position in the direction of the coffee receiving space by way of the piston drive.

The piston axis in particular is arranged perpendicularly to the insertion direction or insertion plane of the portafilter device. In particular, the piston axis runs perpendicularly to the receiving opening of the portafilter device.

The piston tamper of the brewing piston carries out the function of a coffee presser or tamper by way of this pressing or pushing the coffee in the coffee receiving space. The degree of coffee pressing can be determined by the piston pressure which can be set by way of the control device.

The brewing piston remains in its brewing position during the brewing procedure and together with the portafilter device forms the (closed) brewing chamber. The brewing piston can be locked in the brewing position by way of a locking device, in particular a mechanical locking device. The locking device can be actuated for example by the piston drive.

The water pump now pumps water from a water tank into the brewing chamber. The water is heated on its journey via a heating unit. The heated brewing water is led at pressure into the brewing chamber via a brewing water feed which leads through the piston tamper.

The brewed coffee at the lower side of the portafilter device flows downwards out of the portafilter device through a coffee outlet opening, i.e. into a provided drinks vessel.

The feed of hot brewing water is stopped at the end of the brewing procedure and the brewing water pressure in the brewing chamber is reduced. The brewing chamber is opened by way of moving the brewing piston back into its initial position and the receiving opening of the coffee receiving space is released. The portafilter device is now completely removed from the machine unit via a straight-lined (counter) movement via the linear guide device.

The coffee grounds can now be removed from the portafilter device, e.g. by way of knocking it away. The portafilter device can subsequently be prepared for a new brewing procedure.

The coffee machine according to the invention is characterised by the following advantages:
simple and rapid attachment of the portafilter device onto the machine unit and simple and rapid removal of the portafilter device from the machine unit, in particular without significant force effort;
thanks to the movable brewing piston which permits an individual coffee pressing also given a different filling of the coffee receiving space with coffee powder, portafilter baskets of a different size are no longer necessary;
thanks to the movable brewing piston, it is not necessary to tighten the portafilter device against a (stationary) tamper on the machine unit for the pressing of the coffee;
individual setting of the coffee pressing thanks to the brewing piston which via the control device and by way of the piston drive can be advanced into the coffee receiving space or into the brewing chamber in a controlled manner;
residue-free change of the coffee variety thanks to the guide-free delivering of coffee powder out of the cone grinder into the coffee receiving space of the portafilter device.

### BRIEF DESCRIPTION OF THE DRAWINGS

The subject-matter of the invention is hereinafter explained in more detail by way of particular embodiment examples which are represented in the attached figures. In each case schematically are shown in:

FIG. 1a a perspective view of a first embodiment of an arrangement of the brewing unit and the grinder as well as a linear guide device and portafilter device of a portafilter machine, obliquely from the front;

FIG. 1b: a cross section through the arrangement according to FIG. 1a;

FIG. 1c: a further perspective view of the arrangement according to FIG. 1a obliquely from the rear;

FIG. 2: a perspective view of the portafilter device obliquely from above;

FIG. 3: a perspective view of the linear guide device according to FIG. 1a without the portafilter device, obliquely from below;

FIG. 4a: a perspective view of a second embodiment of an arrangement of the brewing unit and grinder as well as the linear guide device and portafilter device of a portafilter machine obliquely from below;

FIG. 4b: a perspective view of the arrangement according to FIG. 4a from the front;

FIG. 4c: a further perspective view of the arrangement according to FIG. 4a from the front;

FIG. 5: a schematic view of a portafilter machine with an arrangement according to FIGS. 1a to 1c;

FIG. 6 a perspective view of the grinder according to FIG. 1a to 1c obliquely from below.

### DETAILED DESCRIPTION OF THE INVENTION

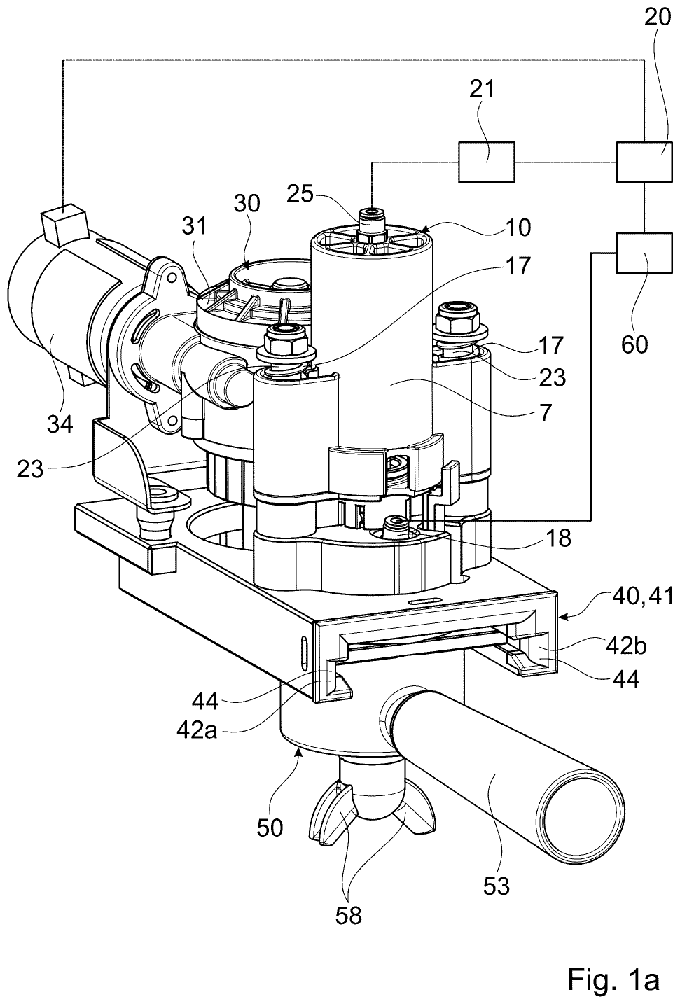

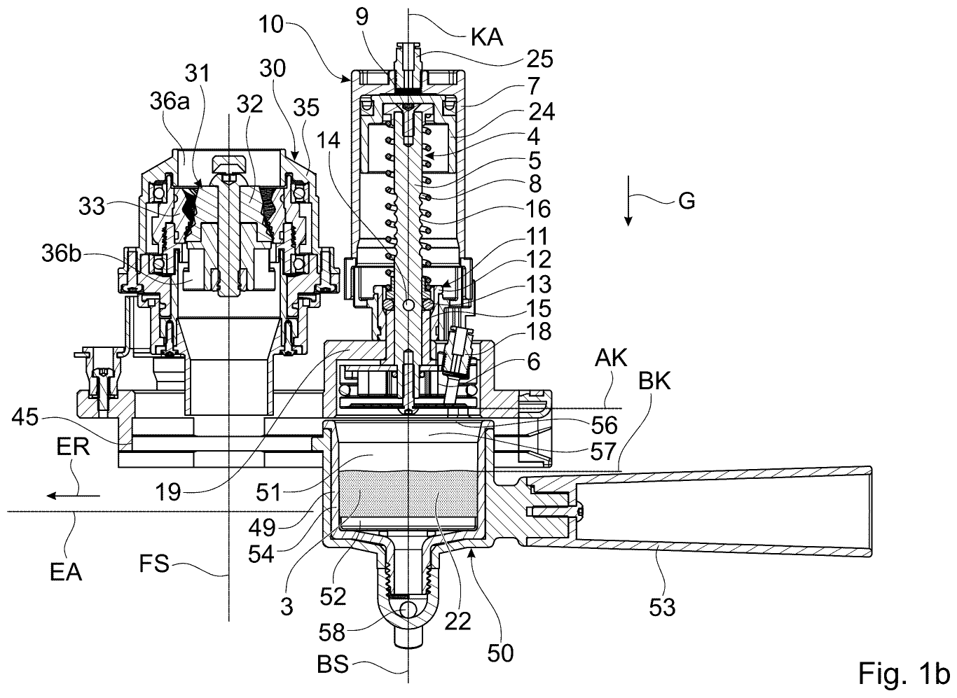

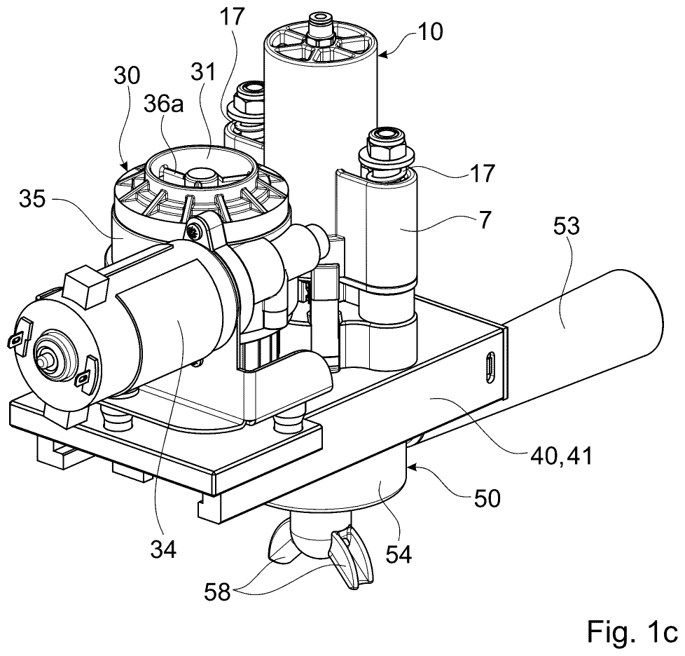

According to a first embodiment according to FIG. 1a to 1c, the coffee machine 1 includes a brewing unit 10 and a device for producing and delivering coffee powder 30 with a cone grinder 31. A holding and guiding device 40 with a linear guide device 41 is arranged below the brewing unit 10 and the device 30. The linear guide device 41 includes two guide rails 42a, 42b which run parallel to one another, are arranged at a distance to one another and each include a guide slot 44 for the sliding receiving of guide bars 55 on a portafilter device 50.

Moreover, the coffee machine 1 includes a portafilter device 50 with a portafilter housing 54 and with a grip body 53 for holding the portafilter device 50. Two guide bars 55 which run parallel to one another laterally on both sides of a receiving opening 56 are arranged on the portafilter device housing 54 at the outside for insertion into the guide slots 44 of the guide rails 42a, 42b.

The brewing unit 10 and the device 30 with the cone grinder 31 are arranged one after the other along the insertion axis EA, wherein the device 30 with the cone grinder 31 is arranged after the brewing unit 10 in the insertion direction ER.

The portafilter device 50 can be pushed into the machine unit 2 of the coffee machine 1 via the guide bars 55 which engage laterally into the guide slots 44 of the guide rails 42a, 42b. The machine unit 2 corresponds to the coffee machine 1 without the portafilter device 50.

The portafilter device 50 amongst others things can be pushed into a filling position FS in which the portafilter device 50 is arranged below the device 30 or the grinder 31. The holding and guiding device 40 forms an end stop 45 which represents an insertion limitation and simultaneously ensures the exact positioning of the portafilter device 50 in the filling position FS for filling the portafilter device 50 with coffee powder 22. This means that the portafilter device 50 assumes the filling position FS on reaching the stop 45.

The cone grinder 31 includes a multipart housing 35 in which the grinding cone 32 and the grinding ring 33 which surrounds the grinding cone 32 are arranged. Coming from the cone base, the grinding cone 32 tapers along the cone axis. The grinding ring 33 is rotatably mounted in the housing 35 about the cone axis of the grinding cone 32 via bearings such as ball bearings and is driven via an electric motor 34. The grinding gap is formed between the grinding ring 33 and the grinding cone 32, into which grinding gap the coffee beans are fed from above and ground by the grinding ring which rotates about the cone axis. The ground coffee powder leaves the grinding gap at the lower end in the region of the cone base and drops downwards due to gravity.

The grinding cone 32 is arranged in a rigid, i.e. non-moved manner and is connected at its two cone ends to the housing 35 via several connection webs 36a, 36b. Coming from the cone axis, the connection webs 36a, 36b run radially outwards towards the housing 35 in a star-like manner.

Several through-openings for letting through coffee beans downwards into the cone grinder 31 in the direction of gravity G are formed at the upper end of the grinding cone between the connection webs 36a (see FIG. 1c).

Several through-openings for letting through coffee powder 22 from the cone grinder 31 downwards into the coffee receiving space 51 of the portafilter device 50 in the direction of gravity G are formed at the lower end of the grinding cone, i.e. on the cone base, between the connection webs 36b.

However, it is not absolutely necessary for the coffee machine to include an integrated grinder as is represented in the figures. The grinder for example can also be arranged or integrated on the coffee machine in a manner such that the portafilter device is filled with coffee powder already before the insertion into the machine unit. Moreover, it is also possible for the coffee machine to have no grinder and for the coffee powder to be obtained from a separate coffee mill or from a supply store.

The portafilter device 50 include a filter basket 49 which is admitted into the portafilter housing 54, with a brewing filter 52 which forms the base of the filter basket 49. The filter basket 49 forms the coffee receiving space 51 for receiving the coffee powder 22. This is open to the top. Accordingly, the filter basket 49 includes a receiving opening 56 to the top. This lies opposite the brewing filter 52. The coffee receiving space 51 is designed in a cylindrical manner but in the region of the receiving opening 56 includes a circumferential, funnel-like widening 57. The filter basket 49 in this embodiment example is fixedly connected to the portafilter housing 54 and accordingly cannot be removed. The filter basket 49 however can also be removable. The filter basket 49 can likewise be an integral constituent of the portafilter housing 54.

Subsequently to the filling of the coffee receiving space 51 of the portafilter device 50 with coffee powder 22, the portafilter device 50 is retracted into the brewing position BS in a linear counter-movement via the linear guide device 41. In the brewing position, the portafilter device 50 is located below the brewing unit 10.

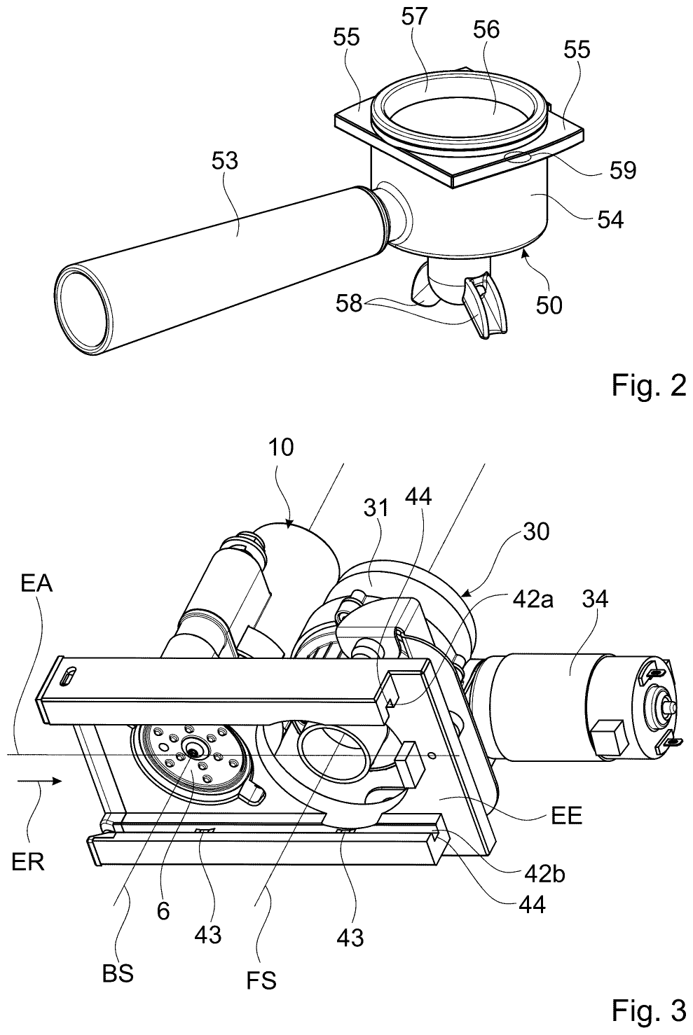

As can be seen more clearly from FIGS. 2 and 3, the linear guide device 41 and the portafilter device 50 include latching means 43, 59 which cooperate with one another and which permit an exact, self-centring positioning of the portafilter device 50 in the brewing position BS. In the present embodiment example, latching notches 41 are formed in the guide slot 44 of the guide rails 42a, 42b, into which notches spring-loaded balls 59 which are arranged on the guide bars 55 of the portafilter device 50 engage. The latching notches 43 each form a run-in ramp in the insertion direction ER and counter to the insertion direction ER. This ramp is to reduce the force effort on pushing or pulling the portafilter device 50 out of the latching position, so that the portafilter device 50 can be pushed or pulled beyond the latching position or be pulled or pushed out of the latching position again without much effort.

The brewing unit 10 includes a brewing piston 4 with a piston rod 5 which is guided in a piston rod housing 7 as well as a piston tamper 6 which is arranged at the lower end, i.e. towards portafilter device 50 and is guided in a piston tamper guide housing 19. The piston tamper guide housing 19 includes a piston rod guide tube 15 through which the piston rod 5 is led from the piston rod housing 7 into the piston tamper guide housing 19. The piston axis KA is perpendicular to the insertion direction ER or insertion plane EE of the portafilter device 50 and accordingly also runs perpendicularly to the receiving opening 56 of the portafilter device 50.

For initiating the brewing procedure, the brewing piston 4 is moved downwards out of its initial position AK towards the coffee receiving space 51 of the portafilter device 50 in the direction of gravity G by way of a piston drive 21. The piston tamper 6 is herein moved into the coffee receiving space 51 and presses or compacts the coffee powder together. In other words, the so-called tampering is carried out by the brewing piston 4. The advance of the brewing piston 4 is completed on reaching the brewing position BK. The coffee receiving space 51 which is closed by the piston tamper 6 now forms a brewing chamber 3.

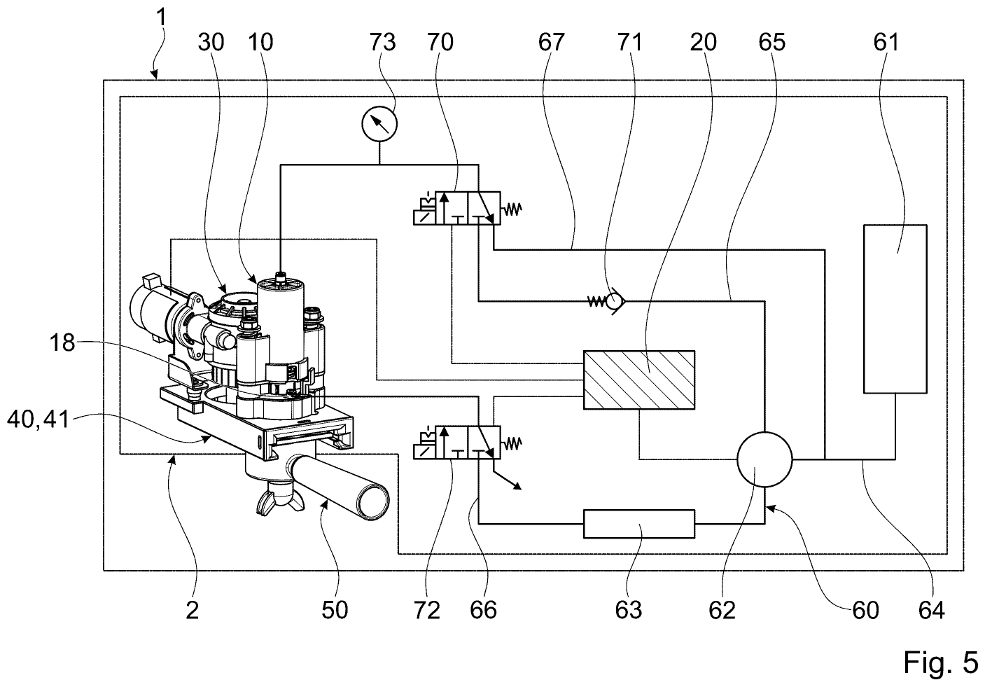

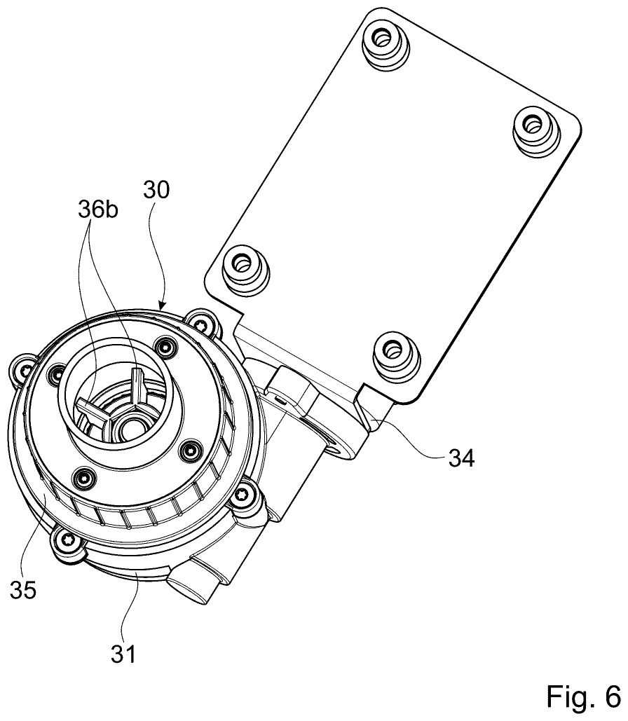

The piston drive 21 and herewith also the piston pressure which in turn is a measure of the coffee pressing are controlled via the control device 20. The piston drive 21 can be an electrical drive or a hydraulic drive. Concerning the latter, as is explained further below in more detail, a hydraulic fluid such as water is led into a pressure chamber 9 via a feed 25. A hydraulic drive of the brewing piston 4 can be effected via the water pump 62 of the brewing water preparation device 60 as is yet explained further below by way of FIG. 5.

The coffee machine or the machine unit 2 further includes a brewing water preparation device 60 with a water tank 61, a water pump 62 and a heating unit 63 for feeding hot water under pressure into the brewing chamber 3 (see also FIG. 5). The hot brewing water is led under pressure into the brewing chamber 3 via a brewing water feed 18 which is led through the piston tamper 6.

The portafilter device 50 includes a coffee outlet opening 58 which is arranged below the brewing filter 52. The coffee which is brewed in the brewing chamber 3 and is pressed through the brewing filter 52 flows away downwards through this, i.e. into a drinks vessel (not represented).

The brewing piston 4 interacts with a restoring spring 8. This spring in the present embodiment corresponds to a compression spring 8 in the form of a helical spring which surrounds the piston rod 5. The compression spring 8 which is pressed together on advancing the brewing piston 4 towards the portafilter device 50 presses the brewing piston 4 back again into its initial position AK after completion of the brewing procedure with the reduction of the piston pressure. Restoring means, such as restoring springs are not necessarily needed given a piston drive 21, such as e.g. an electrical drive which actively moves back the brewing piston 4.

The brewing piston 4 further includes a piston guide sleeve 24 by way of which the brewing piston 4 is axially guided in the piston rod housing 7. The piston guide sleeve 24 is arranged in the upper end section of the brewing piston 4 towards the pressure chamber 9.

According to the present embodiment, the brewing piston 4 is locked in the brewing position BK with respect to an axial direction which is opposite to the advance direction of the brewing piston 4, by way of a locking device 11. The locking amongst other things serves for the relieving of the piston drive 21. Thus the piston pressure which is exerted upon the brewing piston 4 by the piston drive 21 for pressing the coffee powder 22 is significantly lower than the brewing water pressure which is built up in the brewing chamber by the water pump 62 of the brewing water preparation device 60 and which acts upon the brewing piston 4 as a counter-pressure. Thanks to the locking of the brewing piston 4 during the brewing procedure, one does not need to build up a counter-pressure which corresponds to the brewing water pressure, with the piston drive. However, the locking device 11 is not absolutely necessary. Moreover, a locking can also be effected itself by the piston drive 21.

The embodiment according to FIG. 1a to 1c shows a particular embodiment of a locking device which is characterised in that this is likewise activated via the piston drive 21.

In the present case, the piston drive 21 by way of a hydraulic fluid and via a hydraulic pump exerts a hydraulic pressure onto the brewing piston 4. For this, a hydraulic fluid is led into a pressure chamber 9 via a feed 25 such as a piston water feed, said pressure chamber amongst other things being delimited by the movable brewing piston 4. The pressure chamber 9 is not particularly evident in FIG. 1b since this does not extend spatially downwards into the brewing position BK until the movement of the brewing piston 4 downwards out of its initial position AK.

As is yet explained in more detail by way of FIG. 5, the hydraulic pump can also correspond to the water pump 62 of the brewing water preparation device 60 and the hydraulic fluid can be water from the water tank 61 of the brewing water preparation device 60.

On account of the pressure of the hydraulic fluid (e.g. water) which flows into the pressure chamber 9, the brewing piston 4 moves downwards out of its initial position AK in the direction of the portafilter device 50 counter to the restoring force of the restoring spring 8 into the brewing position BK.

The pressure chamber 9 is delimited to the top by the piston rod housing 7. The piston rod housing 7 via two connection screws 23 is axially movably mounted relative to the piston tamper guide housing 19 and accordingly with respect to the piston rod guide tube 15, along the connection screws 23. The connection screws 23 accordingly form an in particular thread-free guide section for the axial guidance of the axially movable piston rod housing 7. The piston rod housing 7 is held in an initial position via two compression springs 17 which press the piston rod housing 7 downwards. The compression springs 17 are designed as helical springs and each surround the connection screws 23.

The axial movement of the brewing piston 4 downwards is ended on reaching the brewing position BK. The pressure which increases further in the pressure chamber 9 now exerts a corresponding force upon the piston rod housing 7, by which means this is moved slightly upwards counter to the restoring force of the compression springs 17, in a direction which is counter to the piston movement.

An annular actuation element 12 of the locking device 11 which is likewise moved upwards and surrounds the piston rod guide tube 15 is also connected to the piston rod housing 7. The actuation element 12 in an upper section forms a radial distance to the piston rod guide tube 15, by which means an annular cavity or gap arises. In a lower section, the actuation element 12 is in sliding contact with the piston rod guide tube 15 and bears on this. The upper and the lower section merge into one another by way of a guide ramp.

The piston rod guide tube 15 includes radial through-openings 14 at the height of the actuation element 12, into which through-openings ball bodies 13 are movably mounted.

The piston rod 4 includes a plurality of recesses 16 which are annularly peripheral and into which the ball bodies 13 can engage.

In the non-locked position, the piston rod housing 7 and with this the actuation element 12 is held in a lower initial position by way of the restoring force of the compression springs 17. The upper section of the actuation element 12 with the annular cavity or gap is located at the height of the radial through-openings 14. The ball bodies 13 are set back from the radial through-openings 14 and engage into the annular cavity.

If now the brewing piston 4 reaches the brewing position BK, then as mentioned the piston rod housing 7 is slightly lifted together with the actuation element 12 in the axial direction. By way of this, the lower section of the actuation element 12 together with the annular gap moves upwards, by which means the ball bodies 13 are displaced back radially inwards into the through-openings 14 due to the lower section which likewise moves upwards. The guide ramp between the upper and the lower section ensures that the ball bodies 13 do not jam with the actuation element 12, but move uniformly into the through-openings 14.

The ball bodies 13 which are displaced back into the radial through-openings 14 now at the other side engage into a recess 16 on the piston rod 15 and effect the locking of the brewing piston 4 in the brewing position BK. The ball bodies 13 consequently act as locking bodies.

The locking remains as long as the hydraulic pressure in the pressure chamber 9 is capable of pressing the piston rod housing 7 upwards against the restoring force of the compression springs 17.

After completion of the brewing procedure, the pressure in the pressure chamber 9 is reduced, by which means the piston rod housing 7 moves back downwards together with the actuation element 12 into the initial position due to the restoring force of the compression springs 17. The upper section of the actuation element 12 together with the annular gap between the actuation element 12 and the piston rod guide tube 15 comes to lie again at the height of the radial through-openings 14.

On account of the reduction of the pressure in the pressure chamber 9, again the restoring force upon the brewing piston 4 which is exerted by the compression spring 8 is dominant. The ball bodies 13 are displaced back out of the recess 16 into the radial through-holes 14 and into the annular gap which lies behind this due to the pressing force of the compression spring 8, respectively due to the brewing piston 4 which is brought into an upwards movement by the compression spring 8.

The locking is lifted and the brewing piston 4 springs back upwards into the initial position AK due to the restoring force of the compression spring 8.

FIG. 5 shows a particular further development of the coffee machine 1 which is characterised in that the brewing piston 4 is driven by the water pump 62 of the brewing water preparation device 60 which is to say advanced in the brewing position BK. The water pump 62 obtains water from the water tank 61 via a feed water conduit 64. The water pump 62 is connected to the brewing water feed 18 on the piston tamper 6 via a brewing water conduit 66. A heating unit 63, i.e. a thermo-block or continuous heater is arranged along the brewing water conduit 66 for heating the brewing water which flows through the brewing water conduit 66. The water pump 62 pumps water out of the water tank 61 under pressure into the brewing chamber 3 via the brewing water conduit 66. The brewing water is heated by the heating unit 63 on its way through the brewing water conduit 66.

A 3/2-way valve 72 is arranged on the brewing water conduit 66, the valve including a further connection for the discharge of residual water into a capture container such as a drip tray, subsequently to the brewing procedure. The 3/2-way valve 72 is switched via the control device 20.

The water pump 62 is further connected to the piston water conduit 65 via which water is pumped out of the water tank 61 into a pressure chamber 9 in the piston rod housing 7 (see FIG. 1b) for advancing the brewing piston 4 from the initial position AK into the brewing position BK.

The piston water conduit 65 includes a check valve 71 which prevents the backflow of water out of the pressure chamber 9 into the water pump 62. Moreover, a 3/2-way valve 70 is arranged in the piston water conduit 65 between the check valve 71 and the pressure chamber 9. A return water conduit 67 via which piston water can be led back into the water tank 61 is connected to the 3/2-way valve 70. A manometer 73 for monitoring the pressure in the pressure chamber 9 is situated on the piston water conduit 65.

For advancing the brewing piston 4 from the initial position AK into the brewing position BK, the water pump 62 pumps water out of the water tank 61 into the piston water conduit 65 and builds up a piston pressure which is specified by the control device 20.

After the brewing piston 4 has reached its brewing position BK and is locked, the water pump 62 amid heating pumps water out of the water tank 61 through the brewing water conduit 66 into the brewing chamber 3 and builds up a brewing pressure which as a rule is greater than the piston pressure.

The water pump 62 is switched between the piston water conduit 65 and the brewing water conduit 66 or between the piston water feed and the brewing water feed via the control device 20. The check valve 71 in the piston water conduit 65 prevents a pressure loss in the pressure chamber 9 on switching the water pump 62 from the piston water conduit 65 to the brewing water conduit 66.

The pressure in the brewing water conduit 66 is relieved at the end of the brewing procedure and the 3/2-way valve is switched by the control device 20 such that the residual water is discharged into a capture container (not shown).

Furthermore, the pressure is also relieved in the piston water conduit 65 and the 3/2-way valve 70 is switched such that the piston water is led back into the water tank 61 via the feed-back water conduit 67.

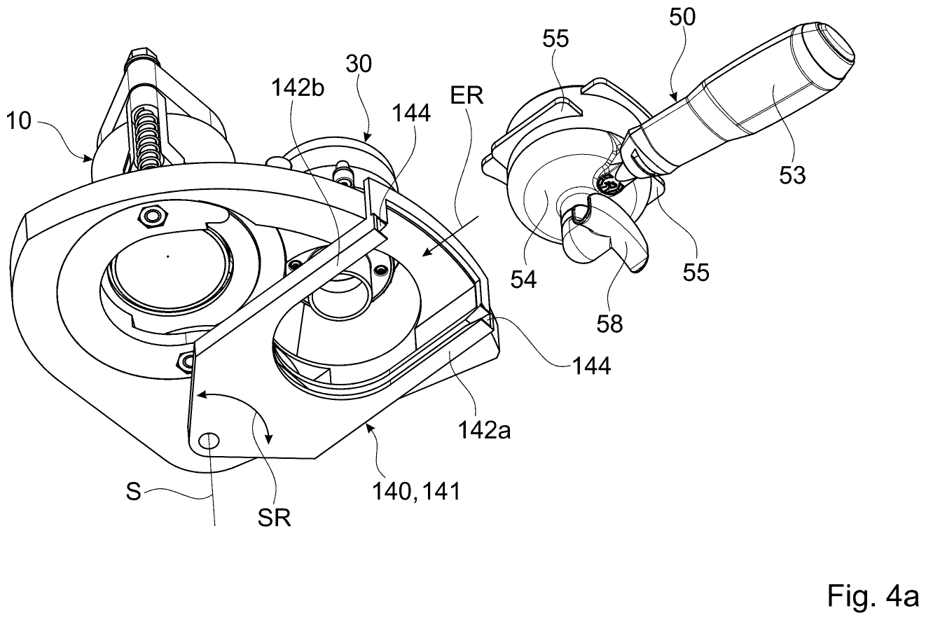

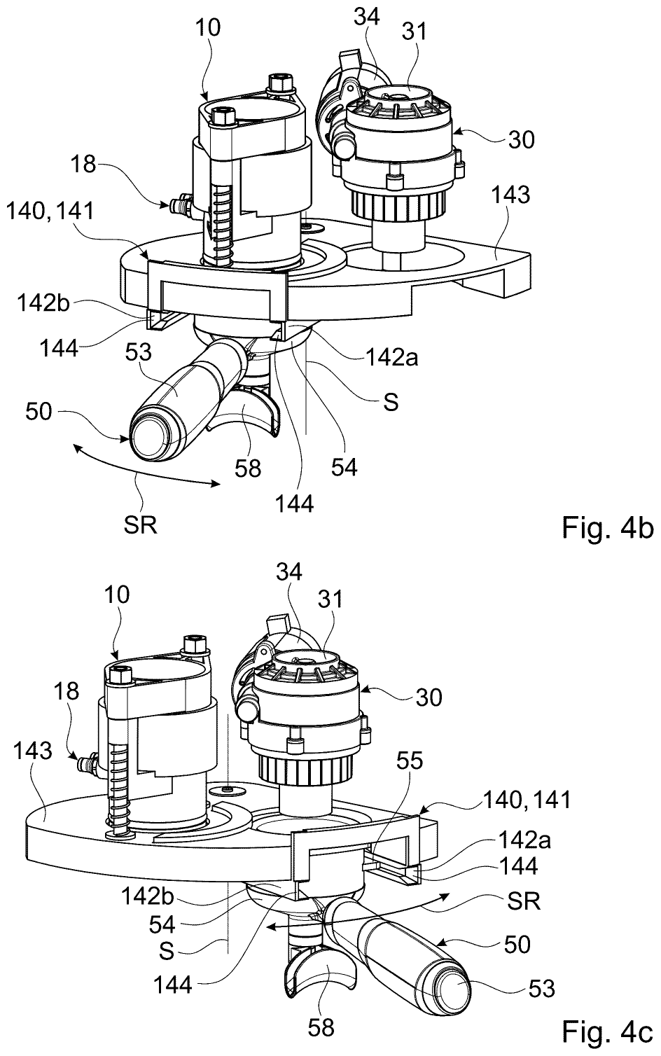

FIGS. 4a to 4c show a second embodiment of a machine unit, respectively a holding and guiding device 140. The holding and guiding device 140 includes a carrier plate 143 on which a linear guide device 141 is pivotably arranged via a pivot axis S.

The linear guide device 141 likewise includes two guide rails 142a, 142b which run parallel to one another, are arranged at a distance to one another and each include a guide slot 144 for the sliding receiving of guide bars 55 of a portafilter device 50. The portafilter device 50 corresponds to the portafilter device 50 according to the first embodiment according to FIGS. 1a to 1c, 2 and 3.

Likewise, the device for producing and delivering coffee powder 30 as well as the brewing unit 10 in particular correspond to those of the first embodiment according to FIGS. 1a to 1c.

The device 30 and the brewing unit 10 and accordingly also the filling position FS and the brewing position BS of the portafilter device 50 however in the second embodiment are not arranged one after the other in the insertion direction. The device 30 and the brewing unit 10 and accordingly the filling position FS and the brewing position BS in contrast are arranged along a (geometrical) circle line whose circle centre is formed by the pivot axis S.

The portafilter device 50 can now be inserted into the linear guide device 141 into a working position with a linear movement. The working position can be set by an insertion limitation such as a stop. The working position is located on the same circle line on which the filling position FS and the brewing position BS are arranged. The portafilter device 50 can now be alternately pivoted into the filling position FS and into the brewing position BS by way of pivoting the portafilter device 50 about the pivot axis S in the pivoting direction SR.

Since according to this embodiment variant only one insertion position, specifically the working position is present, this can be defined by a stop. Latching means, as are provided in the case of two insertion positions lying one after the other according to the first embodiment, are not necessary.

1. A coffee machine, comprising a machine unit and a portafilter device with a coffee receiving space and a brewing filer, said portafilter device being removable from the machine unit, wherein the machine unit comprises a movably mounted brewing piston, a brewing water preparation device for producing and delivering hot water under pressure into the coffee receiving space of the portafilter device, and a holding and guiding device for receiving and holding the portafilter device on the machine unit,
wherein the holding and guiding device comprises a linear guide device for linear insertion of the portafilter device into the machine unit.

2. The coffee machine according to claim 1, wherein the linear guide device comprises two guide contours which run in parallel and are spaced from one another.

3. The coffee machine according to claim 1, wherein the coffee receiving space is arranged in a portafilter housing of the portafilter device, and guide bodies which interacting with the linear guide device form a linear guide are arranged laterally on the portafilter housing.

4. The coffee machine according to claim 1, wherein the portafilter device, which is held in the linear guide device, is movable in the machine unit into a brewing position for brewing a coffee.

5. The coffee machine according to claim 1, wherein the portafilter device can be pushed into the brewing position in a linear movement via the linear guide device.

6. The coffee machine according to claim 1, wherein the machine unit comprises a device for producing and delivering coffee powder into the coffee receiving space of the portafilter device.

7. The coffee machine according to claim 6, wherein the portafilter device, which is held in the linear guide device, is movable in the machine unit into a filling position for delivering coffee powder into the coffee receiving space of the portafilter device.

8. The coffee machine according to claim 6, wherein the portafilter device can be pushed into a filling position in a linear movement via the linear guide, in which filling position the coffee receiving space of the portafilter device can be filled with coffee powder.

9. The coffee machine according to claim 6, wherein the filling position is different from the brewing position.

10. The coffee machine according claim 6, wherein the portafilter device, which is held in the linear guide device, is movable in the machine unit between the filling position and the brewing.

11. The coffee machine according claim 6, wherein the portafilter device is movable in the machine unit in a plane between the filling position and the brewing position.

12. The coffee machine according to claim 6, wherein the movement between the filling position and the brewing position is a linear movement or a pivoting movement.

13. The coffee machine according claim 6, wherein the brewing position and the filling position are arranged behind one another along an insertion axis.

14. The coffee machine according to claim 13, wherein the filling position is arranged after the brewing position in the insertion direction.

15. The coffee machine according to claim 6, wherein the linear guide device is pivotably mounted on the machine unit via a pivot axis which is arranged perpendicularly to the insertion plane and the portafilter device, which is pushed into the machine unit via the linear guide device, is pivotably mounted together with the linear guide between a filling position and the brewing position.

16-18. (canceled)

19. The coffee machine according to claim 1, wherein the means for producing and delivering coffee powder comprises a cone grinder with an inner-lying, stationary grinding cone and with an outer-lying, driven grinding ring which surrounds the grinding cone, wherein the cone grinder is designed and arranged in the machine unit such that the ground coffee powder falls downwards out of the cone grinder without guidance by way of gravitational force into the coffee receiving space arranged below, of the portafilter device which is positioned in the filling position.

20. The coffee machine according to claim 1, wherein the cone grinder comprises a housing which receives the grinding cone and the grinding ring and the stationary grinding cone is connected to the housing via connection webs.

21. A method for brewing a coffee with a coffee machine according to claim 1, comprising the steps of:
for brewing a coffee, pushing the portafilter device into the machine unit by way of a linear movement via the linear guide and after, completion of the brewing procedure, pulling the portafilter device out of the machine unit again in a linear counter-movement.

22. The method according to claim 21, wherein for brewing a coffee, the portafilter device is firstly pushed into a filling position in a linear movement via the linear guide and after the filling of the coffee receiving space with coffee powder is retracted into a brewing position in a linear counter-movement.

23. The method according to claim 21, wherein for brewing coffee, the portafilter device is pushed into the machine unit in a linear movement via the linear guide and for filling the coffee receiving space with coffee powder and for brewing the coffee is pivoted together with the holding and guiding device between a filling position and a brewing position.
